(19) United States
(12) Patent Application Publication
(10) Pub. No.: US 2022/0087118 A1
(43) Pub. Date: Mar. 24, 2022

(54) Water Retention Assembly

(71) Applicant: Mark Fishburn, Fort Collins, CO (US)

(72) Inventor: Mark Fishburn, Fort Collins, CO (US)

(21) Appl. No.: 17/029,674

(22) Filed: Sep. 23, 2020

(51) Int. Cl. A01G 25/02

(52) U.S. Cl. CPC A01G 25/023; A01G 2025/003

(57) ABSTRACT

A water retention assembly for retaining water around a plant includes a barrier that includes a first ring portion integrated into to a second ring portion. The first ring portion can be inserted into ground having the second ring portion surrounding a plant. The barrier is comprised of a fluid impermeable material to retain water around the plant when the plant is watered. Additionally, the barrier has a feed passage extending therethrough to accommodate a supply pipe of a water drip system. In this way to the water drip system can automatically water the plant surrounded by the second ring portion.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to retention devices and more particularly pertains to a new retention device for retaining water around a plant.

### (2) Description of Related Art Including Information Disclosed Under 37 CFR 1.97 and 1.98

The prior art relates to retention devices including a variety of watering devices that comprise a pair of concentric rings for retaining water around a plant and a plurality of drain holes for watering the plant. The prior art discloses a water barrier that includes a pair of concentric rings, one of which is crenellated for penetrating ground. Additionally, the prior art discloses a water battier for surrounding plant which includes a wind screen extending upwardly therefrom.

### BRIEF SUMMARY OF THE INVENTION

An embodiment of the disclosure meets the needs presented above by generally comprising a barrier that includes a first ring portion integrated into to a second ring portion. The first ring portion can be inserted into ground having the second ring portion surrounding a plant. The barrier is comprised of a fluid impermeable material to retain water around the plant when the plant is watered. Additionally, the barrier has a feed passage extending therethrough to accommodate a supply pipe of a water drip system. In this way to the water drip system can automatically water the plant surrounded by the second ring portion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a water retention assembly according to an embodiment of the disclosure.

FIG. 2 is a bottom perspective view of an embodiment of the disclosure.

FIG. 3 is a front view of an embodiment of the disclosure.

FIG. 4 is a bottom view of an embodiment of the disclosure.

FIG. 5 is a cross sectional view taken along line 5-5 of FIG. 3 of an embodiment of the disclosure.

FIG. 6 is a perspective in-use view of an embodiment of the disclosure.

FIG. 7 is a perspective in-use view of an embodiment of the disclosure showing a supply pipe of a water drip system being extended through a feed passage.

### DETAILED DESCRIPTION OF THE INVENTION

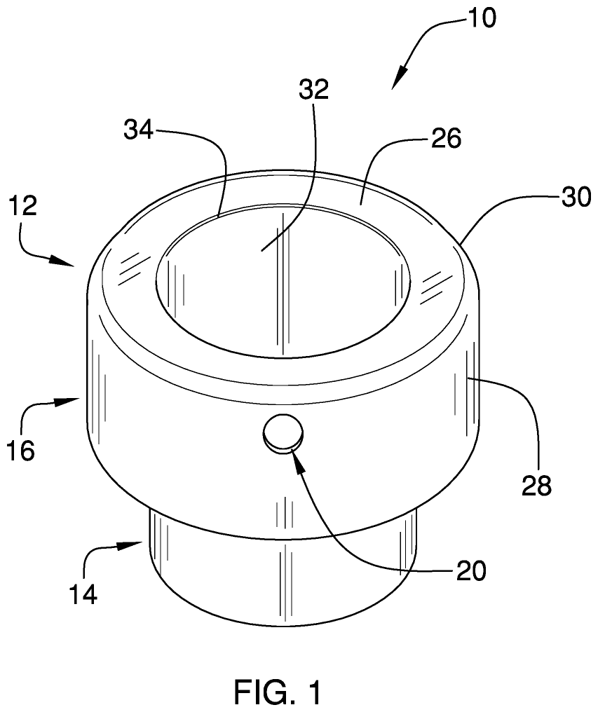

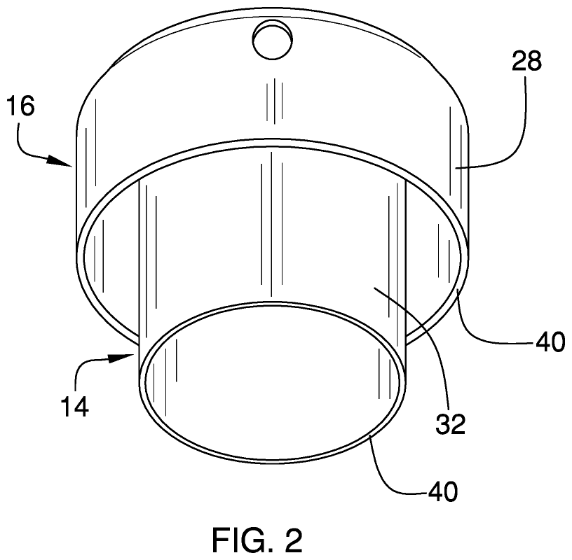

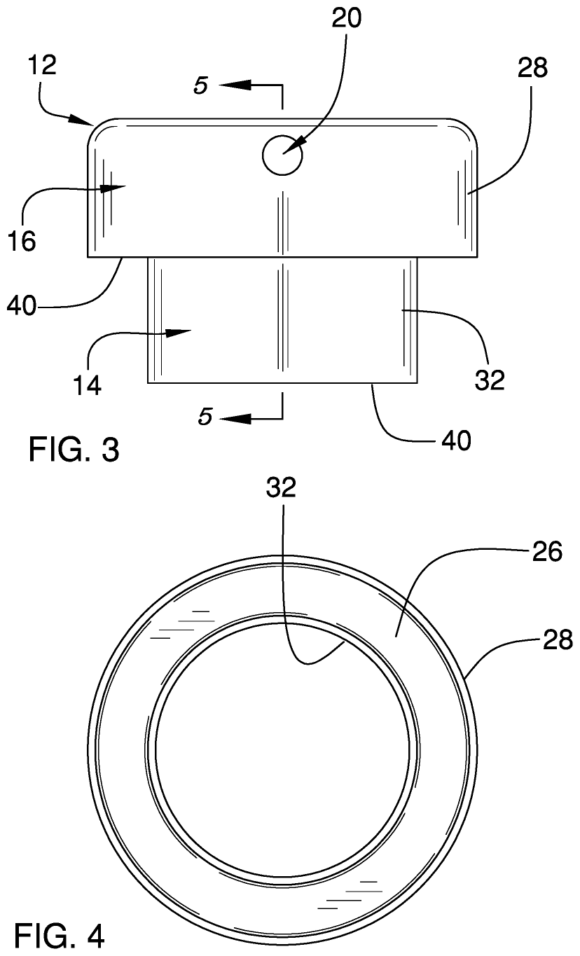

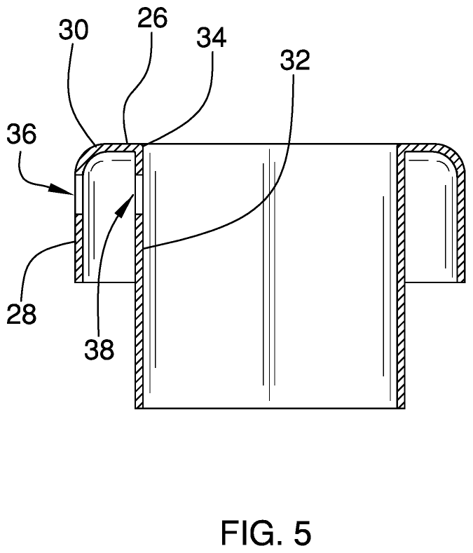

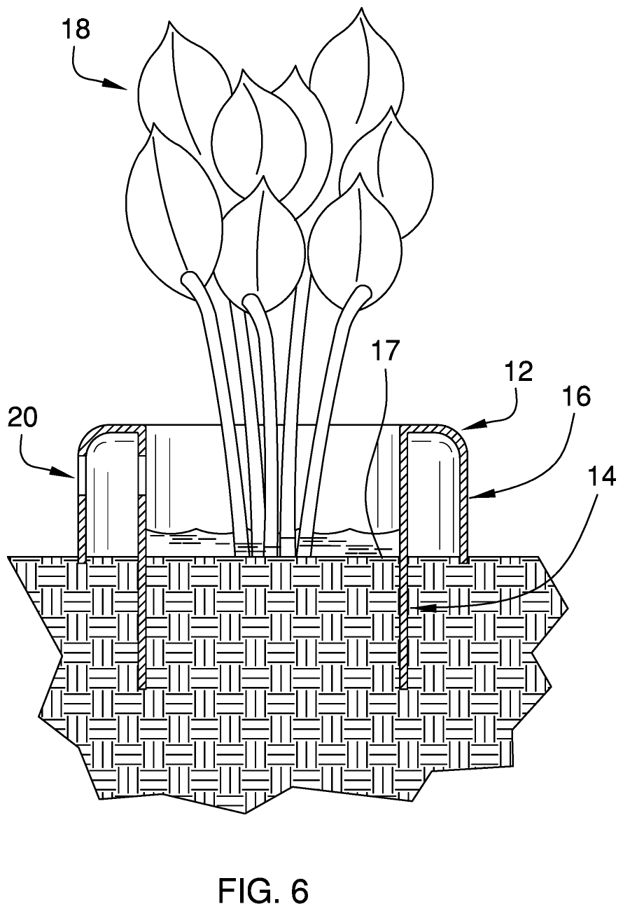

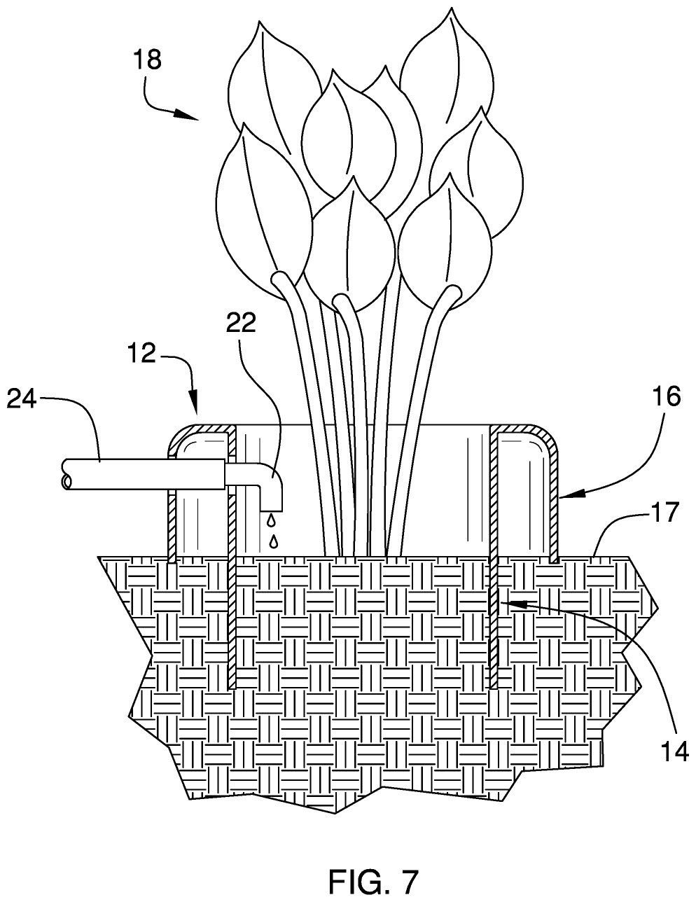

With reference now to the drawings, and in particular to FIGS. 1 through 7 thereof, a new retention device embodying the principles and concepts of an embodiment of the disclosure and generally designated by the reference numeral 10 will be described.

As best illustrated in FIGS. 1 through 7, the water retention assembly 10 generally comprises a barrier 12 that comprises a first ring portion 14 being integrated into to a second ring portion 16. The first ring portion 14 can be inserted into ground 17 having the second ring portion 16 surrounding a plant 18. The plant 18 may be a flower, a vegetable or any other plant that is intentionally grown in a garden or the like. The barrier 12 is comprised of a fluid impermeable material such that the barrier 12 retains water around the plant 18 when the plant 18 is watered. The barrier 12 has a feed passage 20 extending therethrough to accommodate a supply pipe 22 of a water drip system 24. In this way the water drip system 24 can automatically water the plant 18 surrounded by the second ring portion 16.

The second ring portion 16 has a top wall 26 and an outer wall 28 extending downwardly from an outer perimeter 30 of the top wall 26. Additionally, the second ring portion 16 includes an inner wall 32 extending downwardly from an inner perimeter 34 of the top wall 26. Each of the inner wall 32 and the outer wall 28 are continuously arcuate about a center point of the second ring portion 16 such that the second ring portion 16 has a ring shape. The feed passage 20 comprises a first hole 36 extending through the outer wall 28 and a second hole 38 extending through the inner wall 32. The first hole 36 is aligned with the second hole 38, and each of the first hole 36 and the second hole 38 is positioned adjacent to the top wall 26.

Each of the inner wall 32 and the outer wall 28 has a distal edge 40 with respect to the top wall 26. Moreover, the inner wall 32 extends downwardly beyond the outer wall 28 such that the distal edge 40 of the inner wall 32 is spaced below the distal edge 40 of the outer wall 28. The inner wall 32 defines the first ring portion 14 of the barrier 12. Additionally, the first ring portion 14 extends between the distal edge 40 of the outer wall 28 and the distal edge 40 of the inner wall 32. The first ring portion 14 has a diameter that is less than the diameter of the second ring portion 16. The second ring portion 16 may have a diameter ranging between approximately 3.0 inches and 10.0 inches. Additionally, the first ring portion 14 and the second ring portion 16 may have a combined height of at least 3.0 inches.

In use, the first ring portion 14 of the barrier 12 is urged downwardly into the ground 17 such that the second ring portion 16 surrounds the plant 18. In this way the second ring portion 16 retains water around the plant 18 when the plant 18 is watered. Additionally, the supply pipe 22 of the water drip system 24 can be extended through each of the first hole 36 and the second hole 38. In this way the water drip system 24 can automatically water the plant 18 while the second ring surrounds the plant 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A water retention assembly for retaining water around a plant, said assembly comprising:
a barrier comprising a first ring portion being integrated into to a second ring portion wherein said first ring portion is configured to be inserted into ground having said second ring portion surrounding a plant, said barrier being comprised of a fluid impermeable material wherein said barrier is configured to retain water around the plant when the plant is watered, said barrier having a feed passage extending therethrough wherein said feed passage is configured to accommodate a supply pipe of a water drip system to facilitate the water drip system to automatically water the plant surrounded by said second ring portion.

2. The assembly according to claim 1, wherein said second ring portion has a top wall, an outer wall extending downwardly from an outer perimeter of said top wall and an inner wall extending downwardly from an inner perimeter of said top wall.

3. The assembly according to claim 2, wherein said feed passage comprises a first hole extending through said outer wall and a second hole extending through said inner wall, said first hole being aligned with said second hole, each of said first hole and said second hole being positioned adjacent to said top wall.

4. The assembly according to claim 2, wherein each of said inner wall and said outer wall has a distal edge with respect to said top wall, said inner wall extending downwardly beyond said outer wall such that said distal edge of said inner wall is spaced below said distal edge of said outer wall.

5. The assembly according to claim 4, wherein said inner wall defines said first ring portion of said barrier that extends between said distal edge of said outer wall and said distal edge of said inner wall.

6. A water retention assembly for retaining water around a plant, said assembly comprising:
a barrier comprising a first ring portion being integrated into to a second ring portion wherein said first ring portion is configured to be inserted into ground having said second ring portion surrounding a plant, said barrier being comprised of a fluid impermeable material wherein said barrier is configured to retain water around the plant when the plant is watered, said barrier having a feed passage extending therethrough wherein said feed passage is configured to accommodate a supply pipe of a water drip system to facilitate the water drip system to automatically water the plant surrounded by said second ring portion, said second ring portion having a top wall, an outer wall extending downwardly from an outer perimeter of said top wall and an inner wall extending downwardly from an inner perimeter of said top wall, said feed passage comprising a first hole extending through said outer wall and a second hole extending through said inner wall, said first hole being aligned with said second hole, each of said first hole and said second hole being positioned adjacent to said top wall, each of said inner wall and said outer wall having a distal edge with respect to said top wall, said inner wall extending downwardly beyond said outer wall such that said distal edge of said inner wall is spaced below said distal edge of said outer wall, said inner wall defining said first ring portion of said barrier that extends between said distal edge of said outer wall and said distal edge of said inner wall.
